(19) United States
(12) Patent Application Publication
(10) Pub. No.: US 2012/0174932 A1
(43) Pub. Date: Jul. 12, 2012

(54) PROTECTIVE MOUTH GUARD

(76) Inventor: Anthony Lamont Wilson, Chino, CA (US)

(21) Appl. No.: 13/345,479

(22) Filed: Jan. 6, 2012

Related U.S. Application Data
(60) Provisional application No. 61/460,902, filed on Jan. 10, 2011.

(51) Int. Cl. A61C 5/14

(52) U.S. Cl. 128/861

(57) ABSTRACT

A protective mouth guard primarily for use in contact sports has a handle that is convenient to hold while taking the mouth guard in and out of the mouth and while holding it. Some embodiments have about a ¾″ by ¾″ area for two-fingered holding; some have a downward extending loop providing for one-fingered holding. Versions also have a loop for being retained on a helmet face guard in addition to a shaft portion that provides a place other than the in-mouth portion for grasping while performing the face guard retention action.

### RELATED APPLICATIONS

This application claims the benefit of U.S. provisional application 61/460,902 filed Jan. 10, 2011 under 35 USC section 119(e), which is hereby incorporated herein by reference in its entirety.

### FIELD

This disclosure is related to mouth guards for mouth and teeth protection, particularly when playing a contact sport.

### BACKGROUND

The areas of the body that are often in need of protection when playing contact sports include the jaw, tongue, teeth, gums, and other areas of the mouth. Relatively soft plastic mouth guards that go in the mouth, that are U-shaped, fit the pattern of teeth, and bitten by the user are well known. Improvements made in the basic design have been developed to address problems with the use of mouth guards. Potential problems and areas for improvement have included what to do with the mouth guard while not immediately in use, but at the ready for instant use. Other improvements have addressed the case when the mouth guard will not be in use for several minutes. It is highly desirable for answers to those questions to be hygienic.

Between plays, and particularly when on the sidelines, mouth guards are generally removed as they are somewhat uncomfortable and interfere with speaking, drinking, and eating. While out, they should be kept sanitary and not be held or retained in a manner likely to have them be dropped, lost, or mixed up. Of course it is also highly desirable that the configuration provide for and encourage handling not requiring placing fingers on the in-mouth portions.

One partial solution has been the tethered mouth guard. These devices have a long thin flexible strap that comes from the center of the bottom of the “U” and extends outward. The strap is intended to be looped around a face guard or other portion of a helmet. This is a partial solution at best. It does not address helmetless sports like soccer or even sports with helmets that do not have a face guard portion like baseball or boxing.

What is needed is an improved mouth guard with characteristics that include many of the following: in a hygienic manner provide convenience and enhance the players experience while the mouth guard is in place, while it is out briefly, while it is being taken out and being put back, and for short-term storage.

### SUMMARY

Some embodiments of the present teaching include mouth guards with a handle protruding from the mouth guard that provides for convenient one or two-finger holding without the handle requiring structural elements that extend above the plane of the upper teeth when in use. Others have a loop for attaching to a face guard, also known as a facemask without requiring touching the in-mouth portion.

### BRIEF DESCRIPTION OF THE DRAWINGS

FIG. 1 shows a perspective view of a first embodiment of a mouth guard;

FIG. 2 is a side view of the device of FIG. 1;

FIG. 3 is a plan view of the device of FIG. 1;

FIG. 4 is a front view of the device of FIG. 1;

FIG. 5 is a perspective view of a second embodiment mouth guard having a rectangular solid handle extending downward;

FIG. 6 is a perspective view of a third embodiment mouth guard having a solid rectangular handle extending forward;

FIG. 7 is a perspective view of a fourth embodiment mouth guard having a handle extending downward;

FIG. 8 is a perspective view of a fifth embodiment with a tether strap and a loop handle;

FIG. 9 is a plan view of the device of FIG. 8;

FIG. 10 is a side view of the device of FIG. 8;

FIG. 11 is a perspective view of a sixth embodiment mouth guard with a tether strap and a downward depending rectangular solid handle;

FIG. 12 is a plan view of a seventh embodiment mouth guard having a torus shaped handle in-line with a tether strap;

FIG. 13 is a perspective view of the device of FIG. 12;

FIG. 14 shows a player grasping a mouth guard of the first embodiment with one finger through the loop;

FIG. 15 shows a mouth guard attached to a helmet face guard and being held off the ground;

FIG. 16 shows a partial view, close-up of a mouth guard being slipped on to a mask without the in-mouth portion being touched;

FIG. 17 shows a helmet with a mouth guard tethered to a lower face guard bar and retained at an upper face guard bar.

### DETAILED DESCRIPTION

Reference herein to “one embodiment” or “an embodiment” means that a particular feature, structure, operation, or other characteristic described in connection with the embodiment may be included in at least one implementation of the invention. However, the appearance of the phrase “in one embodiment” or “in an embodiment” in various places in the specification does not necessarily refer to the same embodiment.

In conjunction with the included drawings this detailed description is intended to impart an understanding of the teachings herein and not to define their metes and bounds.

Introduction to the Problem

Mouth guards, also known as mouth protectors, mouthpieces, gum guards, and gum shields, provide protection on the mouth region, particularly for contact sports. As mentioned above they are frequently removed and replaced in the course of a game, match or round. For use in football, many mouth guards have a long thin tether that is attached to a low point on a face guard. This allows spiting out the mouthpiece with out it hitting the ground and retaining the mouth guard from loss. However, It is awkward to put the mouth guard back in one's mouth without touching the in-mouth surfaces. Also, since the tether is long and attached at a low point in the face guard it will rest on the ground when the helmet is removed and set down. These are undesirable properties. Also it is possible for the tether to be distracting in the user's lower peripheral vision. Others have provided short, very small, semi-rigid snap-fit protrusions to mouth guards. They are designed to be attached to an upper part of a face guard and avoid the pervious problem. However, they have a deficiency in requiring touching of in-mouth portions to remove and replace the mouth guard as well as to perform the operations of securing and un-securing the snap-fit from the bar of the face guard.

Structure

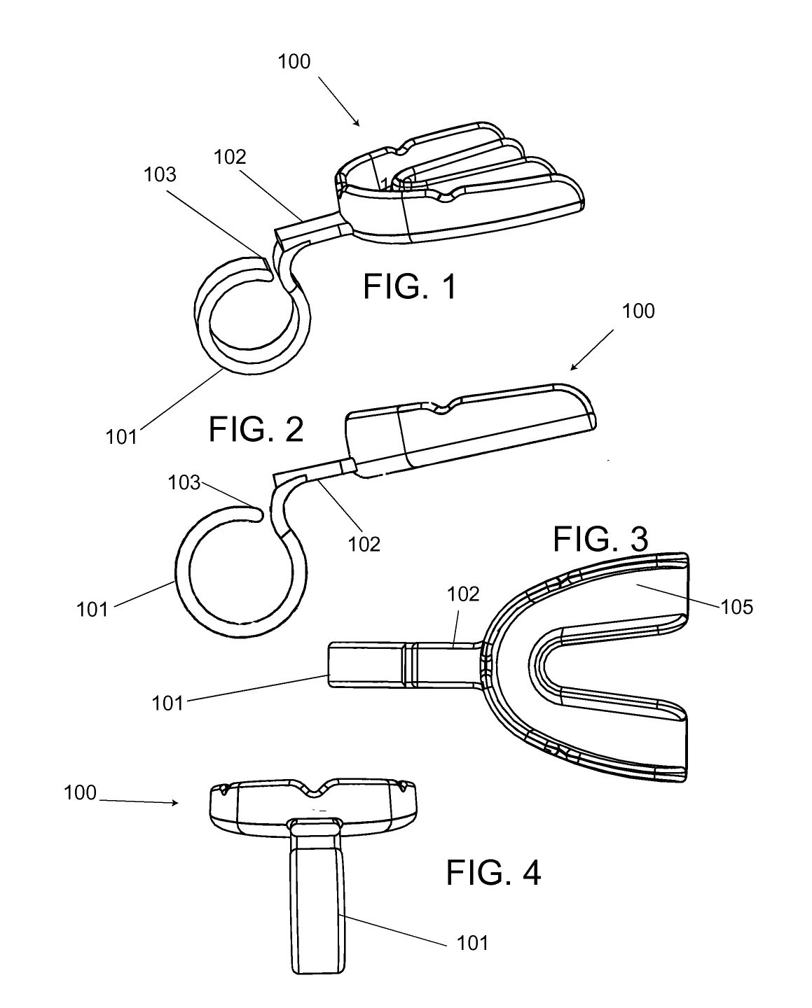

FIGS. 1-5 show a first embodiment according to these teachings. It has a U- shaped in-mouth guard 100. This is a tray having a floor 105. The tray is generally curved in the pattern of the teeth in an intended user's mouth. Protruding straight out from the front of the protector (at the bottom of the U) is a support shaft 102. To be effective, its length is long enough to fully exit the user's lips but short enough to not be in the way of the user's movements and vision. Depending downward from the end of the shaft is a loop 101 of a resilient material. As seen in FIG. 1 the loop is open and ends with a terminus 103 near the distal end of the shaft. This loop is of a size to resiliently grasp an inserted finger and without the requirement to use a second hand, the tip portion of the thumb or the tip portion of a second finger. That size is also effective in a two-fingered grasp with opposing finger and thumb touching the opposing sides of the loop.

As seen in the plan view of FIG. 3, the shaft 102 proper is about a fingers width in length. This allows the shaft to be used as a handle as well as having the loop available as a handle.

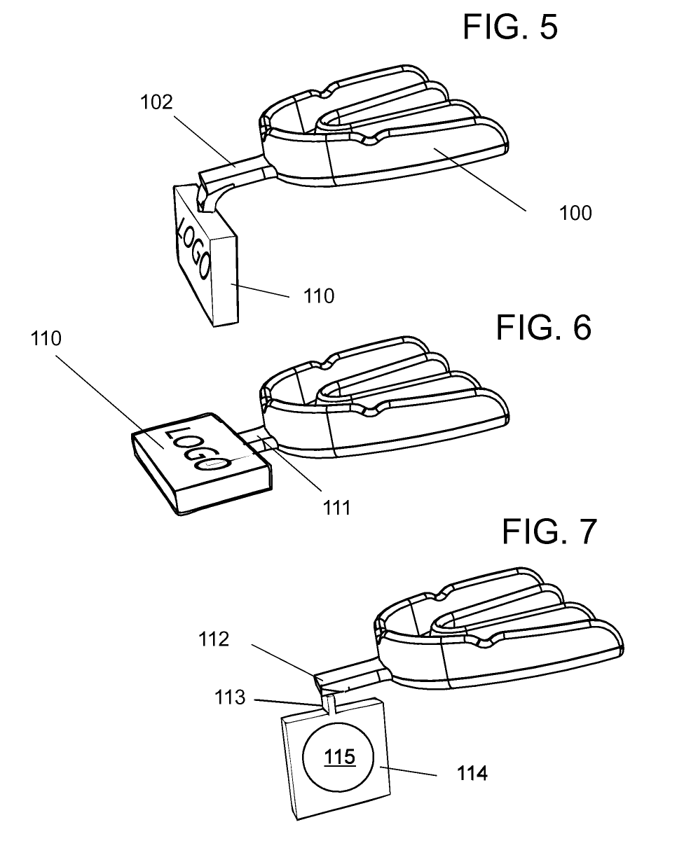

FIGS. 5-7 show three alternative embodiments that do not have a loop. FIG. 5 has a mouth guard 100, a shaft 102 and a downward depending, flat rectangular solid 110 with one of its larger sized surfaces facing squarely forward. This structure can be thought of a finger hold with two opposing surfaces to be readily griped with opposing thumb and finger. A recessed central area can enhance the ability to use the finger hold to readily hold the device.

FIG. 6 shows a similar embodiment with a shaft 111 attached to the rectangular solid 110. In this version the large side is facing straight upward.

FIG. 7 has a rectangular solid, shown as a square shape 114 connected to a vertical post 113. The short vertical post depends downwardly from a shaft 112. The shaft is connected to a mouth guard. In this version, the square handle has a recessed circular region 115 for enhanced finger holding. In variations of this embodiment the inner circular region can be a through-hole rather than a recess.

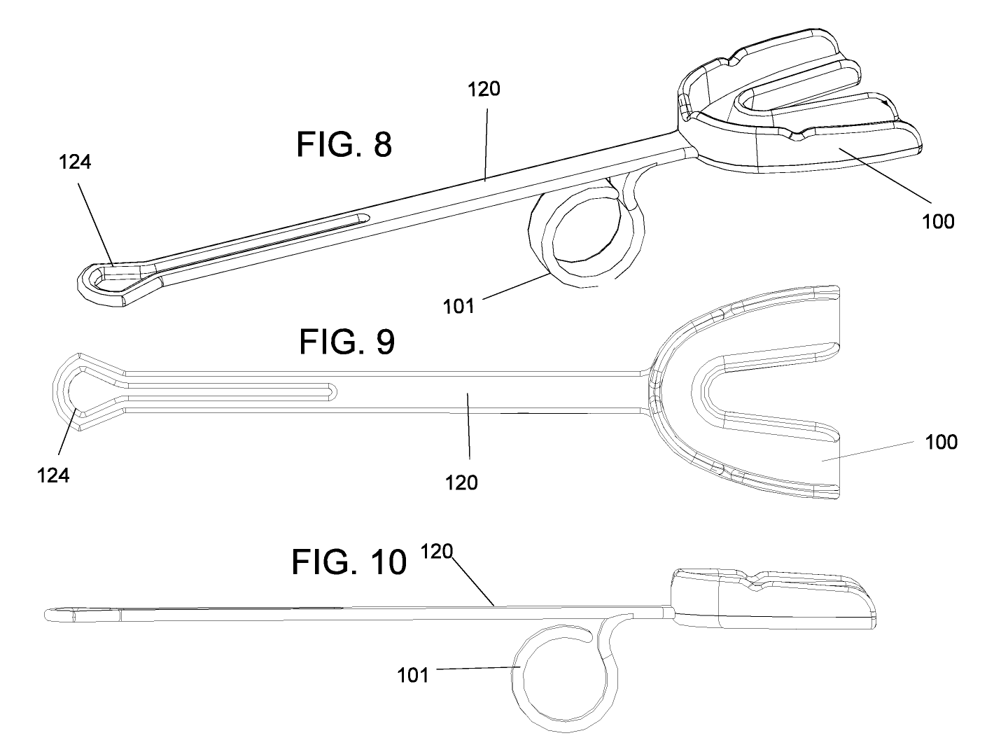

FIGS. 8-10 show an embodiment very similar to the first embodiment seen in FIGS. 1-4. The present version additionally has a long thin strap 120 tether. It terminates in an open area 124. As in the first embodiment, there is a handle comprising a loop 101 and a mouth protector 100.

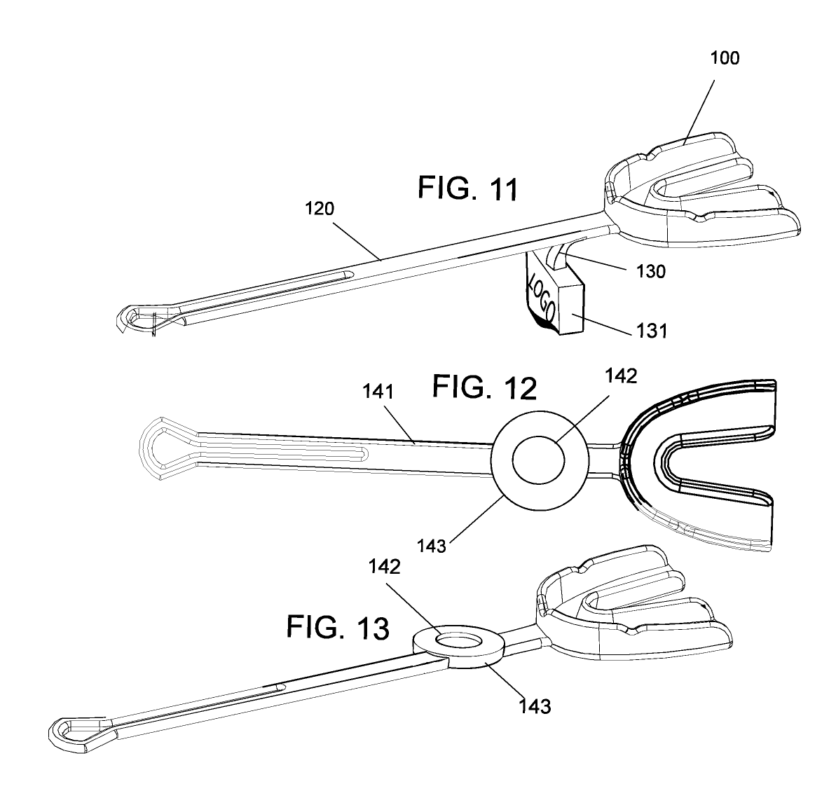

FIG. 11 shows another embodiment with a tether 120. In this version, the handle 131 is a forward-facing rectangular solid. Variations can optionally have an embossed logo and be of other shapes than a rectangle. A Diamond, circle, triangle or even an irregular shape can be effective as long as the region to be grasped has about 1″ by 1″ of material. Additionally one or both sides might have a concave or recessed shape to enhance the handles effectiveness.

FIGS. 12 and 13 show a version with a tether strap 141 that is in-line with a toroidal-shaped two-finger handle 143. The central region 142 can either be an open area as in a proper toroid or in other versions can be a recessed region.

Operation

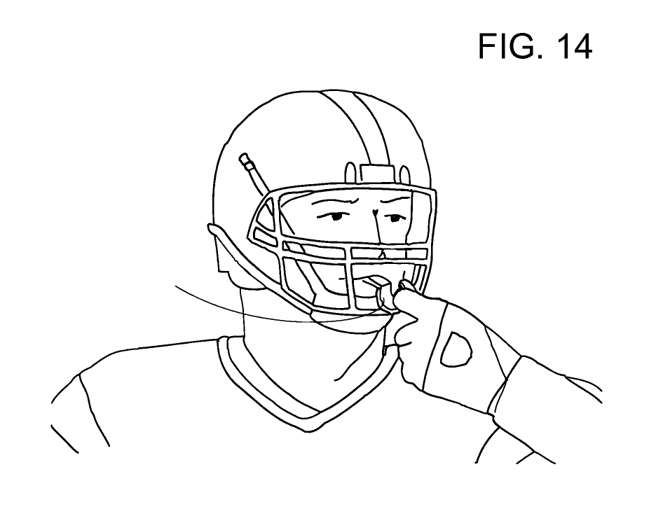

In the various embodiments and versions presented, there is an external portion that can act as an effective handle. To insert the mouth guard, the handle is grasped with two fingers, or in the case of the first and sixth embodiments, with one finger through a loop as seen in FIG. 14. The mouth protector portion is then brought to the users lips, and inserted into the mouth. Biting down completes the insertion steps. During these steps there was no requirement or incentive to touch any of the in-mouth surfaces.

To remove the mouth protector, the mouth is opened and the handle portion is grasped by two fingers or in the case of the first and sixth embodiments, optionally by one figure inserted in their loops. If the mouth guard is to be replaced in a short amount of time it can be retained in the same manner as it was grasped. In the case of a version with a one-finger hold, this is particularly convenient.

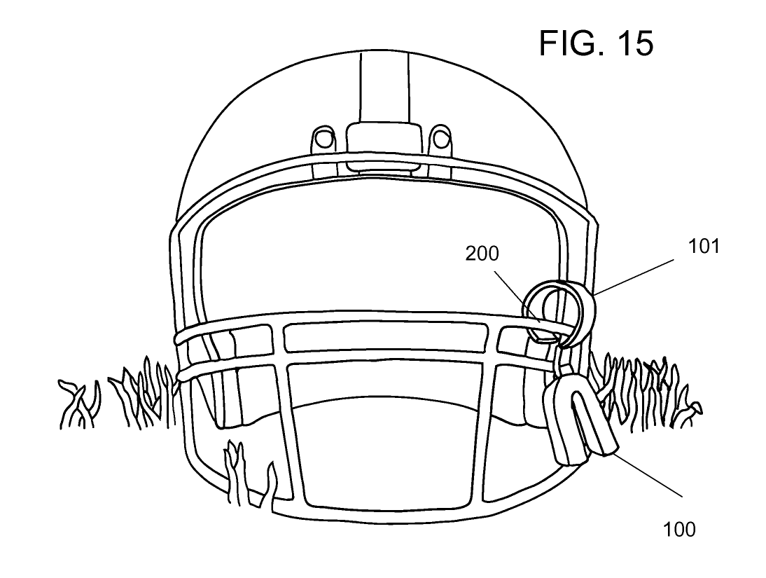

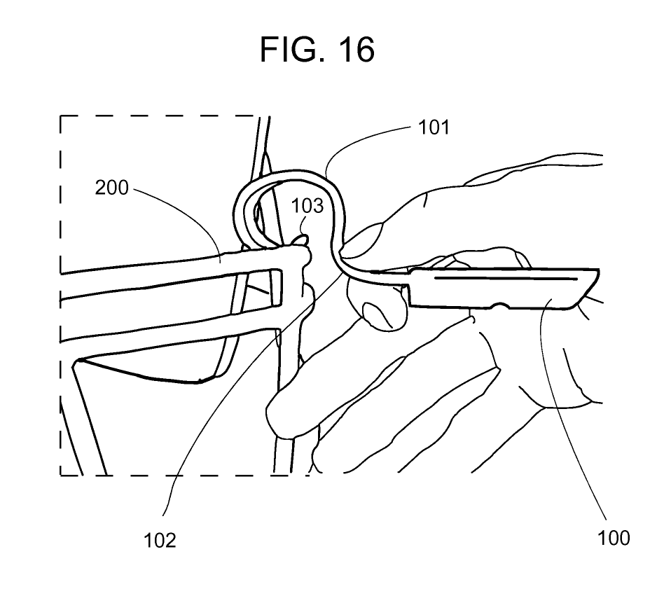

For versions with a loop the mouth guard can be attached to a bar on the face guard 200 as seen in FIG. 15, when playing football or other game with a helmet and face guard,. That operation is done by grasping the shaft 102 with thumb and forefinger. With the shaft as a handle, the open end 103 of the resilient loop 101 is hooked over a bar in the face guard 200. That operation does not require or incent the touching of any surface of the in-mouth portion. This operation is shown in FIG. 16.

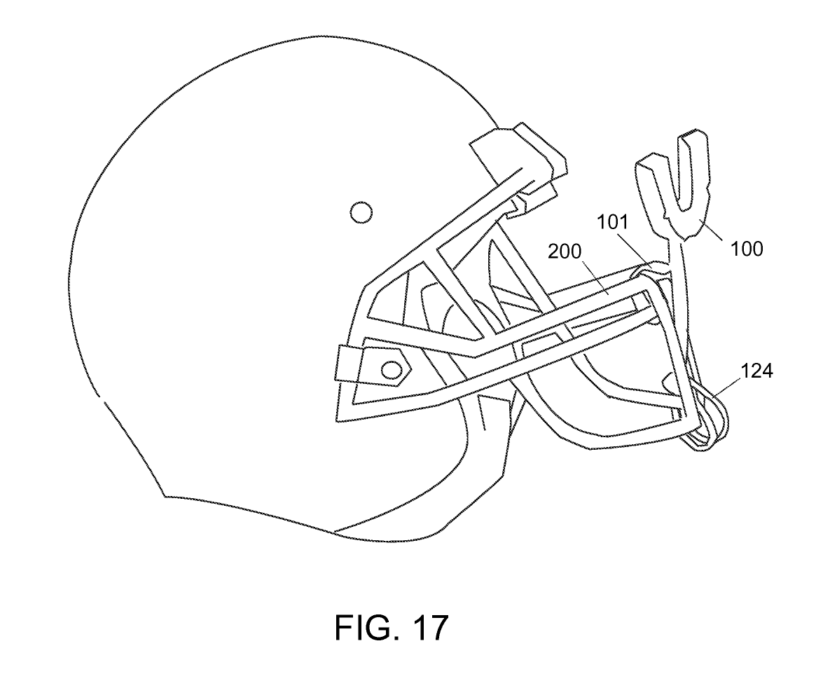

FIG. 17 shows the embodiment of FIG. 8 tethered to the face guard of a helmet. The narrow closed loop 124 at the end of the tether is around a lower bar. In addition, the handle portion's larger open resilient loop 101 is around an upper bar 200 of the face guard. In this position, the mouth protector or guard 100 is well secured with no portion touching the ground.

Operation of Tether Versions

Some embodiments have a tether strap as well as a handle. In these versions the tether can be secured to a lower portion of a face guard. With a tether, the mouth guard can be spat out without risk of hitting the ground. However, by additionally having a handle, the protector can be reinserted in the mouth straightforwardly without touching in-mouth surfaces. If the helmet is to be removed and set down, embodiments with both a strap and a loop can be retained to an upper helmet bar as described above.

Other Considerations in Operation

Anything distracting to the player is unwelcome. The handles shown and described have an outward and sometimes downward aspect. This minimizes the visual distraction to the player.

Those skilled in the art will be aware of materials, techniques, and equipment suitable to produce the example embodiments presented as well as variations on the those examples. This teaching is presented for purposes of illustration and description but is not intended to be exhaustive or limiting to the forms disclosed. Many modifications and variations will be apparent to those of ordinary skill in the art. The embodiments and versions help to explain the principles of the invention, the practical application, and to enable others of ordinary skill in the art to understand it. Various embodiments with various modifications as are suited to the particular application contemplated are expected.

In the following claims, the words “a” and “an” should be taken to mean “at least one” in all cases, even if the wording “at least one” appears in one or more claims explicitly. The scope of the invention is set out in the claims below.

What is claimed:

1. A mouth guard comprising: a generally U-shaped in-mouth portion so configured and shaped as to generally follow the pattern of teeth in a mouth and a handle portion extending outward from the in-mouth portion to a degree to clear the user's lips when in use;
further, the handle portion defines an opening shaped and sized to accommodate a user's forefinger extending through the opening to readily grasp the handle portion with that one finger and not requiring the thumb tip or other finger tips for grasping; the region of the opening being at least semi-rigidly connected to the in-mouth portion such that firmly grasping the opening region provides positive positional control of the in-mouth portion.

2. The mouth guard of claim 1 where the region defining the opening is of a resilient material.

3. The mouth guard of claim 1 where the opening is generally circular.

4. The mouth guard of claim 3 where the opening is defined by an open, resilient loop.

5. The mouth guard of claim 4 where the loop is coupled to the in-mouth portion by an outward extending shaft of at least ¾″ in length and the loop descends from the shaft.

6. The mouth guard of claim 5 where the loop opening is oriented in a left-right orientation relative to a user with the mouth guard in place.

7. The mouth guard of claim 6 where the loop has two opposing, parallel planar sides; further the sides of the loop are sized and shaped to be readily grasped by a user's opposed thumb and forefinger respectively.

8. The mouth guard of claim 1 further comprising a distinct elongated tether strap.

9. A mouth guard comprising: a generally U-shaped in-mouth portion so configured and shaped as to generally follow the pattern of teeth in a mouth and a finger hold handle portion extending outward from the in-mouth portion;
further, the handle portion comprises a generally planar region with two opposing, parallel planar sides; the finger hold does not extend above the plane of the user's upper teeth; further the sides of the finger hold are sized and shaped to be readily grasped by a user's opposed thumb and forefinger respectively.

10. The mouth guard of claim 9 where each side of the finger hold presents a grasping surface at least ¾″ by ¾″.

11. The mouth guard of claim 10 where the grasping surfaces includes a central void and the grasping surface is perimetric.

12. The mouth guard of claim 9 where the finger hold's sides are in planes such that grasping the finger hold in use would be a left-right oriented grasp.

13. The mouth guard of claim 9 where the finger hold's sides are in planes such that grasping the finger hold in use would be a front-back oriented grasp.

14. The mouth guard of claim 9 where the finger hold's sides are in planes such that grasping the finger hold in use would be an up-down oriented grasp.

15. The mouth guard of claim 10 where at least one of the finger hold's sides has a recessed central area for enhanced finger holding.

16. The mouth guard of claim 10 where at least one of the finger hold's sides has a logo.

17. The mouth guard of claim 9 where the finger hold is generally the shape of a solid rectangle.

18. The mouth guard of claim 9 further comprising a distinct elongated tether strap.

19. A mouth guard comprising: a mouth portion and a handle portion, the handle portion extending outward from the mouth portion; the handle portion comprise two regions; one region is a resilient open portion sized and shaped as to be resiliently retained around an object the size of a face guard bar; the second region providing a two-finger graspable handle, graspable with an opposed thumb and forefinger to readily allow the user to retain the open resilient portion on an object of the shape and size of a face guard bar with one hand while not requiring touching of the mouth portion.

20. The mouth guard of claim 19 where the resilient open portion is a downward depending open loop of a diameter at least ¾″ and the two-finger graspable handle portion is a shaft coupling the loop to the mouth portion.

21. The mouth guard of claim 20 where the opening in the loop is on the side of the loop proximate to a user's face when in use.

22. The mouth guard of claim 19 where an object of the shape and size of a face guard is a rod of a diameter of about ¼″.

23. The mouth guard of claim 19 further comprising a distinct elongated tether strap.
